(19) United States
(12) Patent Application Publication
(10) Pub. No.: US 2026/0084584 A1
(43) Pub. Date: Mar. 26, 2026

(54) METHOD OF PRECONDITIONING AN ENERGY STORAGE DEVICE FOR A LIMITED ROUTE OF TRAVEL

(71) Applicant: GM GLOBAL TECHNOLOGY OPERATIONS LLC, Detroit, MI (US)

(72) Inventors: Abbas Mohammed, Whitby (CA); Joseph F. Szczerba, Grand Blanc, MI (US); Reza Zarringhalam, Whitby (CA)

(73) Assignee: GM GLOBAL TECHNOLOGY OPERATIONS LLC, Detroit, MI (US)

(21) Appl. No.: 18/890,843

(22) Filed: Sep. 20, 2024

(51) Int. Cl. B60L 58/27; B60L 7/10

(52) U.S. Cl. CPC B60L 58/27; B60L 7/10; B60L 2240/545; B60L 2240/68; B60L 2260/52; B60L 2260/54

(57) ABSTRACT

A method of preconditioning an energy storage device for a vehicle includes determining a route of travel of the vehicle based on a destination input and estimating a maximum energy available from regenerative braking of the vehicle along the route of travel. The method further includes selecting a target preconditioning temperature for the energy storage device based on the route of travel and the maximum energy available from regenerative braking, and heating the energy storage device to the target preconditioning temperature to thereby precondition the energy storage device. A vehicle includes the energy storage device and a controller in communication with the energy storage device.

### INTRODUCTION

The disclosure relates to a method of preconditioning an energy storage device and to a vehicle.

An energy storage device for a vehicle, such as a rechargeable battery and battery pack for an electric vehicle, may be preconditioned or prepared for optimal performance by warming or cooling the energy storage device. Such preconditioning may optimize efficiency, range, and lifespan of the energy storage device. During preconditioning in a cold climate or when the electric vehicle has been idle for a period of time, the energy storage device may receive electrical energy from an electrical grid or heat from a vehicle thermal management system to warm the energy storage device.

### SUMMARY

A method of preconditioning an energy storage device for a vehicle includes determining a route of travel of the vehicle based on a destination input, and estimating a maximum energy available from regenerative braking of the vehicle along the route of travel. The method further includes selecting a target preconditioning temperature for the energy storage device based on the route of travel and the maximum energy available from regenerative braking, and heating the energy storage device to the target preconditioning temperature to thereby precondition the energy storage device.

In one aspect, the energy storage device may have a full preconditioning temperature, and heating may include warming the energy storage device to less than the full preconditioning temperature.

In an additional aspect, selecting may include balancing the maximum energy available from regenerative braking with an energy required for heating the energy storage device to thereby avoid unnecessary preconditioning of the energy storage device.

In another aspect, estimating may include assessing each opportunity for regenerative braking along the route of travel and rejecting outliers.

In a further aspect, estimating may include measuring a distance of the route of travel.

In one aspect, estimating may include evaluating a duration of travel.

In an additional aspect, estimating may include evaluating traffic volumes and traffic speeds along the route of travel.

In another aspect, estimating may include analyzing weather conditions along the route of travel.

In a further aspect, estimating may include evaluating a grade of the route of travel.

In one aspect, the route of travel may connect a starting location of the vehicle and a destination of the vehicle. Selecting the target preconditioning temperature may include evaluating a soak time of the energy storage device at the destination based on a soak time input and a destination departure time input.

In an additional aspect, the method may further include monitoring a driving behavior of the vehicle along the route of travel.

In another aspect, the method may further include assigning a confidence factor to the target preconditioning temperature.

In a further aspect, the target preconditioning temperature may be a minimum temperature that the energy storage device requires to capture the maximum energy available from regenerative braking for the route of travel. The method may further include, after heating, converting kinetic energy of the vehicle to electrical energy during at least one of deceleration of the vehicle and frictional braking of the vehicle while the vehicle is traveling along the route of travel, and transmitting the electrical energy to the energy storage device to thereby charge the energy storage device.

In another embodiment, a method of preconditioning an energy storage device for a vehicle includes determining a route of travel of the vehicle based on a destination input, wherein the route of travel connects a starting location of the vehicle and a destination of the vehicle. The method also includes evaluating a duration of travel along the route of travel and comparing the duration of travel to a threshold duration of travel. If the duration of travel is less than or equal to the threshold duration of travel, the method includes estimating a maximum energy available from regenerative braking of the vehicle along the route of travel; selecting a target preconditioning temperature for the energy storage device based on the route of travel, the duration of travel, and the maximum energy available from regenerative braking; and heating the energy storage device to the target preconditioning temperature to thereby precondition the energy storage device.

In one aspect, the method may further include monitoring a driving behavior of the vehicle and assigning a confidence factor to the target preconditioning temperature based on the driving behavior.

In an additional aspect, selecting the target preconditioning temperature may include evaluating a soak time of the energy storage device at the destination based on a soak time input and a destination departure time input.

In another aspect, the method may further include predicting the destination input, a soak time input, and a destination departure time input based on a time of day.

In a further aspect, the method may further include scheduling the heating according to the destination input and a starting departure time.

A vehicle includes an energy storage device configured to store and discharge electrical energy and a controller in communication with the energy storage device. The controller includes an instruction set that is executable to determine a route of travel of the vehicle based on a destination input. The instruction set is also executable to estimate a maximum energy available from regenerative braking of the vehicle along the route of travel. The instruction set is further executable to select a target preconditioning temperature of the energy storage device based on the route of travel and the maximum energy available from regenerative braking. In addition, the instruction set is executable to heat the energy storage device to the target preconditioning temperature to thereby precondition the energy storage device.

In one aspect, the vehicle may further include a plurality of wheels configured to translate along the route of travel. The energy storage device may be configured to provide motive power to at least one of the plurality of wheels.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a side view of a vehicle having a controller in communication with an energy storage device and including an instruction set to execute a method of preconditioning the energy storage device.

FIG. 2 is a schematic illustration of the method executable by the controller of FIG. 1.

FIG. 3 is a schematic illustration of another embodiment of the method of FIG. 2.

FIG. 4 is a schematic illustration of a user display device configured for receiving one or more inputs for the methods of FIGS. 1 and 2.

FIG. 5 is a schematic illustration of another embodiment of the user display device of FIG. 4.

### DETAILED DESCRIPTION

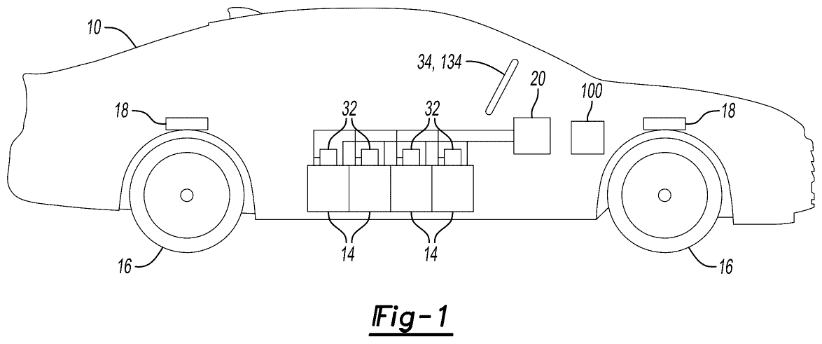

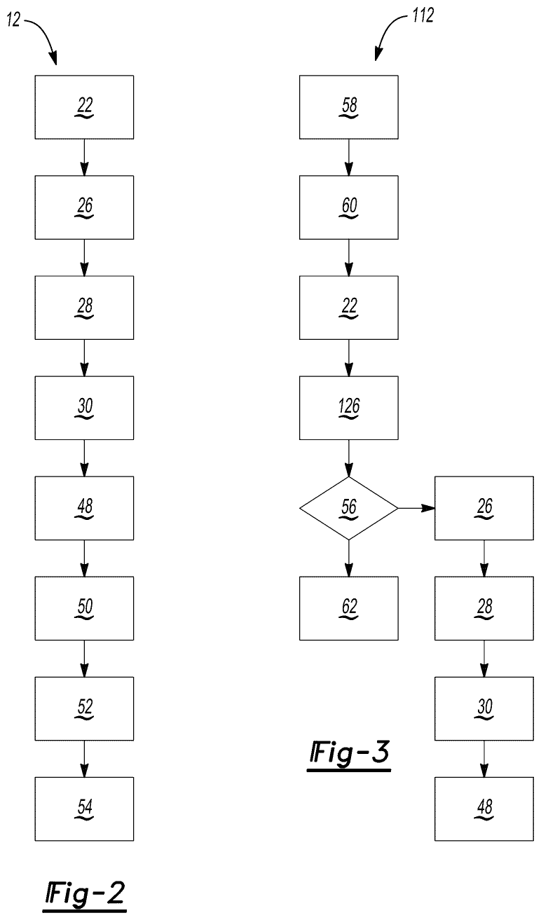

Referring to the Figures, wherein like reference numerals refer to like elements, a vehicle 10 (FIG. 1) and a method 12, 112 (FIGS. 2 and 3) of preconditioning an energy storage device 14 (FIG. 1) for the vehicle 10 are shown generally. The method 12, 112 may be useful for applications requiring excellent performance, range, and lifespan of the energy storage device 14. In particular, the method 12, 112 may be useful for preconditioning the energy storage device 14 in preparation for short or limited travel, e.g., in distance and/or duration, of the vehicle 10.

More specifically, and as set forth in more detail below, the method 12, 112 may provide a target preconditioning temperature for the energy storage device 14 that is sufficient to warm the energy storage device 14 so that the energy storage device 14 may capture an optimal amount of energy available from regenerative braking of the vehicle 10 during the short or limited travel, while avoiding wasted energy associated with unnecessary or excessive preconditioning of the energy storage device 14. That is, since energy from regenerative braking may not be efficiently captured by a comparatively cold energy storage device 14, and since a capacity for the energy storage device 14 to accept electrical energy from regenerative braking may decrease as a temperature of the energy storage device 14 decreases, the method 12, 112 may precisely precondition and warm the energy storage device 14 in preparation for a comparatively short distance or duration trip so that the energy storage device 14 can capture as much energy from regenerative braking as possible without wasting energy required for preconditioning.

As such, the method 12, 112 and vehicle 10 may be useful for automotive applications such as, but not limited to, electric vehicles, hybrid vehicles, and the like. For example, the vehicle 10 may be a motor vehicle powered by at least one of an internal combustion engine 100 (FIG. 1), an electric motor 18 (FIG. 1), and the energy storage device 14. Alternatively, the method 12, 112 and vehicle 10 may be useful for non-automotive applications such as, but not limited to, aerospace, aviation, marine, mass transportation, agricultural, industrial, and rail applications. For example, the vehicle 10 may be, but is not limited to, a commercial vehicle, industrial vehicle, passenger vehicle, aircraft, watercraft, train, or the like. It is also contemplated that the vehicle 10 may be a mobile platform, such as an airplane, all-terrain vehicle (ATV), boat, personal movement apparatus, robot, and the like to accomplish the purposes of this disclosure.

Referring now to FIG. 1, the vehicle 10 includes the energy storage device 14 configured to store and discharge electrical energy. For example, the energy storage device 14 may be a rechargeable, high voltage battery or battery pack. As shown in FIG. 1, the vehicle 10 may include a plurality of energy storage devices 14 electrically connected to one another to provide an output power to the vehicle 10. That is, the vehicle 10 may include a plurality of wheels 16, e.g., steerable and/or non-steerable wheels, configured to translate along a ground surface along a route of travel. Further, the energy storage device 14 may be configured to provide motive power to at least one of the plurality of wheels 16. That is, in some embodiments, the vehicle 10 may be an electric vehicle 10 that receives motive power from the energy storage device 14. As such, the vehicle 10 may include one or more electric motors 18 associated with each of the plurality of wheels 16 and configured for driving the plurality of wheels 16. In other embodiments, the vehicle 10 may include an internal combustion engine 100 that may cooperate with the energy storage device 14 to provide motive power to the plurality of wheels 16.

The vehicle 10 also includes a controller 20 in communication with the energy storage device 14 and including an instruction set that is executable to precondition the energy storage device 14, as set forth in more detail below. That is, the controller 20 may execute the method 12, 112 of preconditioning the energy storage device 14 described below. In particular, the controller 20 may include a processor configured to operate programmed code and may operate an operating system. The processor may include random access memory (RAM) and a memory storage device such as a hard drive. The controller 20 may include programming to analyze data from the energy storage device 14 and vehicle 10 and diagnose existence of a precursor condition of the method 12, 112. The controller 20 may also include programming to take further actions regarding aspects of the method 12, 112, such as heating 30 (FIGS. 2 and 3) the energy storage device 14, ending 62 (FIG. 3) the method 12, 112, electrically communicating with the energy storage device 14, automatically scheduling 60 (FIG. 3) preconditioning of the energy storage device 14, monitoring 48 (FIGS. 2 and 3) driving behavior of the vehicle 10, and the like.

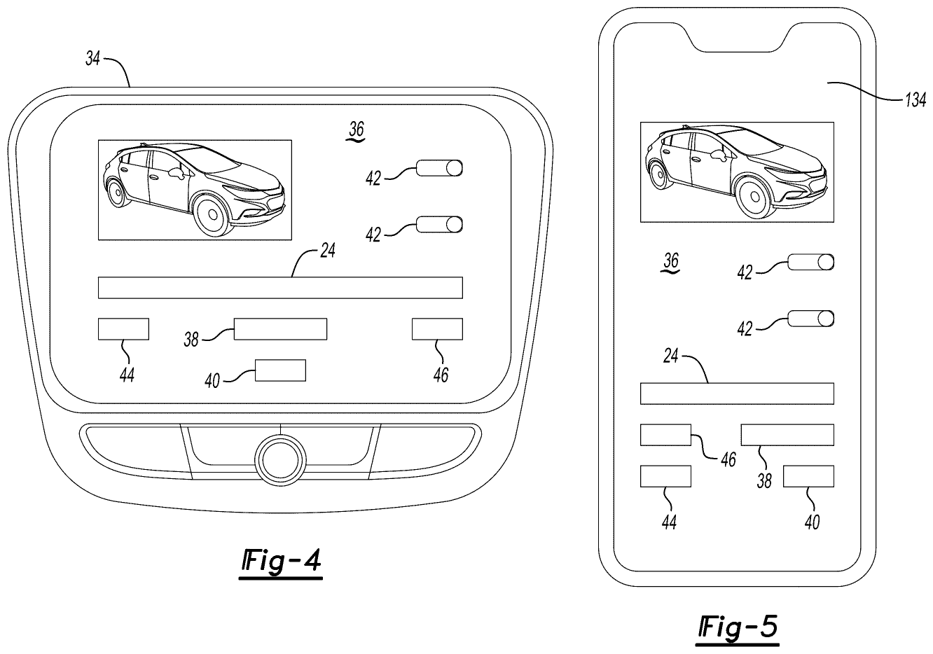

More specifically, as set forth in more detail below and described with reference to FIGS. 2 and 3, the controller 20 includes the instruction set that is executable to determine 22 a route of travel of the vehicle 10 based on a destination input 24 (FIGS. 4 and 5); estimate 26 a maximum energy available from regenerative braking of the vehicle 10 along the route of travel; select 28 a target preconditioning temperature of the energy storage device 14 based on the route of travel and the maximum energy available from regenerative braking; and heat 30 the energy storage device 14 to the target preconditioning temperature to thereby precondition the energy storage device 14.

In addition, although not shown in detail, the vehicle 10 may include a communications bus configured for enabling electronic communication between components of the vehicle 10. Each energy storage device 14 may include a sensor 32 (FIG. 1), and the sensor 32, the controller 20, the energy storage device 14, and a user display device 34, 134 (FIGS. 4 and 5) or human machine interface may be electrically connected to the communication bus and may transmit data and computerized commands therethrough to execute the aspects of the method 12, 112.

As shown in FIGS. 1 and 4, the vehicle 10 may also include the user display device 34 or human machine interface configured for receiving inputs from a driver or passenger of the vehicle 10. For example, the user display device 34 may include a computerized touch screen display 36 that may be configured to receive the destination input 24, a departure time input 38, a time at destination input 40, and the like, and may include toggle switches 42 configured to actuate various aspects of the method 12, 112. For example, the toggle switches 42 may activate the method 12, 112 or portions of the method 12, 112. In another embodiment as shown in FIG. 5, the user display device 134 may be configured as an input screen or graphical user interface for a mobile communication device such as a cellular telephone.

Referring again to FIG. 2, the method 12 of preconditioning the energy storage device 14 for the vehicle 10 includes determining 22 a route of travel of the vehicle 10 based on the destination input 24. For example, a user of the vehicle 10 may provide an intended destination of the vehicle 10 as the destination input 24 to the user display device 34 before departure. The route of travel may connect a starting location of the vehicle 10, which may be obtained from, for example, global positioning coordinates or other vehicle telemetry, and a destination of the vehicle 10. Based upon the starting location, an onboard computer or controller 20 of the vehicle 10 may ascertain the route of travel connecting the starting location and the destination.

Referring again to FIG. 2, the method 12 also includes estimating 26 a maximum energy available from regenerative braking of the vehicle 10 along the route of travel. Regenerative braking may be described as an energy recovery mechanism that slows down the moving vehicle 10 by converting kinetic energy of the vehicle 10 into another form of energy, e.g., electrical energy, that can be used immediately or stored for later use. For purposes of an electric vehicle 10 or hybrid vehicle 10, kinetic energy may be converted to electrical energy and stored in the energy storage device 14. Preconditioning the energy storage device 14 before travel, especially in extreme climates or after a period of nonuse, may ready the energy storage device 14 to accept and store the electrical energy. That is, preconditioning may enable the energy storage device 14 to capture energy from regenerative braking.

By way of non-limiting example, during regenerative braking, the one or more electric motors 18 (FIG. 1) of the vehicle 10 that drive the plurality of wheels 16 may function as a generator when the vehicle 10 decelerates, e.g., when a user of the vehicle 10 releases an accelerator pedal of the vehicle 10 or applies the frictional brakes of the vehicle 10. As the plurality of wheels 16 turn each electric motor 18 during deceleration of the vehicle 10, the electric motors 18 may convert the kinetic energy of the vehicle 10 to electrical energy, which may create a magnetic drag that further slows the vehicle 10. During regenerative braking, power flow is reversed so that, rather than the energy storage device 14 powering each electric motor 18, each electric motor 18 instead transmits electrical energy to the energy storage device 14. The generated electrical energy may be used to charge the energy storage device 14 and recover energy that would otherwise be lost as heat during deceleration and braking of the vehicle 10.

As described with continued reference to FIG. 2, estimating 26 the maximum energy available from regenerative braking may include assessing each opportunity for regenerative braking along the route of travel and rejecting outliers. That is, estimating 26 may include assessing various characteristics of the route of travel and casting or filtering out results that are different from a main group of results.

For example, if 80% of the expected regenerative braking along the route of travel may be attributable to gradual grade changes, but 20% of the maximum energy available from regenerative braking along the route of travel may be attributable to one long, steep descent, it may not be worthwhile to completely precondition the energy storage device 14 to a full preconditioning temperature, since complete preconditioning requires using comparatively more energy than partial preconditioning. That is, the long, steep descent may be an outlier and may not be considered by the method 12, 112.

In another example, the current flow of traffic may be filtered out as an outlier if traffic volumes or speeds affect deceleration opportunities of the vehicle 10. As such, estimating 26 assists in tailoring the method 12, 112 to the specific route of travel so that energy is not wasted in heating 30 the energy storage device 14 to merely capture energy from a spike in regenerative braking.

Likewise, for comparatively short distance and/or duration travels, it may not be advantageous to warm the energy storage device 14 to the full preconditioning temperature if the route of travel does not include opportunities for regenerative braking. Therefore, estimating 26 seeks to obtain a tailored or precise target preconditioning temperature that is high enough to ready the energy storage device 14 to accept electrical energy converted during regenerative braking, but not too high that preconditioning spends warming energy that is ultimately wasted because there is not sufficient electrical energy transmitted back to the energy storage device 14 during regenerative braking.

In one non-limiting example, estimating 26 may include measuring a distance of the route of travel and predicting whether or how many opportunities for regenerative braking exist along the distance. Similarly, estimating 26 may include evaluating 126 (FIG. 3) the duration of travel, or how long the vehicle 10 may spend traveling between the starting location and the destination, and again assessing opportunities for regenerative braking of the vehicle 10 along the route of travel.

Additionally or alternatively, estimating 26 may include evaluating traffic volumes and traffic speeds along the route of travel. For example, estimating 26 may consider whether stop-and-go traffic is present along the route of travel. Likewise, estimating 26 may include analyzing weather conditions along the route of travel when estimating regenerative braking opportunities along the route of travel. For example, estimating 26 may consider inclement weather along the route of travel.

In another example, estimating 26 may include evaluating a grade of the route of travel. For example, estimating 26 may include analyzing a number and severity of changes in grade, inclinations, and declinations along the route of travel and predicting the maximum energy available from regenerative braking. Estimating 26 may also include considering a mass of the vehicle 10.

Referring again to FIG. 2, the method 12 of preconditioning the energy storage device 14 also includes selecting 28 a target preconditioning temperature for the energy storage device 14 based on the route of travel and the maximum energy available from regenerative braking, and heating 30 the energy storage device 14 to the target preconditioning temperature to thereby precondition the energy storage device 14. That is, the energy storage device 14 may have a full preconditioning temperature, and heating 30 may include warming the energy storage device 14 to less than the full preconditioning temperature. For example, heating 30 may include increasing an operating temperature of the energy storage device by plugging the vehicle 10 into an electrical utility grid or activating thermal management components of the vehicle 10, such as resistive heaters, heat pumps, and the like.

The target preconditioning temperature may be described as a minimum temperature that the energy storage device 14 requires to capture the maximum energy available from regenerative braking for the route of travel. Therefore, selecting 28 may include balancing the maximum energy available from regenerative braking with an energy required for heating 30 the energy storage device 14 to thereby avoid unnecessary or excessive preconditioning of the energy storage device 14. Selecting 28 may include finding a sweet spot or ideal balance so that warming the energy storage device 14 before travel via energy such as electrical energy from a plug connected to an electrical utility grid allows the energy storage device 14 to capture as much energy from regenerative braking as possible during travel.

For example, in some instances, the route of travel may include one steep, downward-descending hill that may provide an opportunity for regenerative braking of the vehicle 10. However, if the amount of electrical energy required to precondition the energy storage device 14 to accept all of the electrical energy generated during regenerative braking on the hill is large, it may not be optimal to precondition the energy storage device 14 before travel to a level sufficient to capture all of the energy from regenerative braking on the hill, from both an energy cost and time perspective. Instead, it may be desirable to precondition the energy storage device 14 to an optimal level, i.e., to the target preconditioning temperature, that is less than the full preconditioning temperature to thereby avoid unnecessary or excessive preconditioning and capture an optimum amount of energy available from regenerative braking, rather than the maximum amount of energy available from regenerative braking along the route of travel.

In another example, as described with continued reference to FIG. 2, selecting 28 the target preconditioning temperature may also include evaluating a soak time of the energy storage device 14 at the destination based on the soak time input 44 (FIGS. 4 and 5) and a destination departure time input 46 (FIGS. 4 and 5). The soak time input 44 may refer to how long the vehicle 10 will remain at the destination and not in use so that an internal temperature of the energy storage device 14 stabilizes. The destination departure time input 46 may refer to a desired departure time of the vehicle 10 from the destination. Either or both of the soak time input 44 and the destination departure time input 46 may be entered into the user display device 34, 134 by the user of the vehicle 10 in preparation for potential preconditioning.

For example, for comparatively long soak times such as when the vehicle 10 will remain at the destination for an 8-hour work day after a comparatively short route of travel such as a 10 minute commute to work, it may not be advisable to precondition the energy storage device 14 to the full preconditioning temperature, since the energy required to warm the energy storage device 14 during preconditioning may be wasted if the vehicle 10 is not used again for 8 hours. In this scenario, the energy storage device 14 may lose most of the electrical energy from a utility grid that was used to precondition the energy storage device 14 if the energy storage device 14 is cold soaked in a comparatively cold temperature for 8 hours after use.

Conversely, however, if the soak time is comparatively short, e.g., a quick 10-minute stop, it may be worthwhile to expend the electrical energy to warm up the energy storage device 14 so that further energy from regenerative braking may be captured when the vehicle 10 is again underway. Therefore, the method 12 includes selecting 28 the tailored target preconditioning temperature that avoids unnecessary or excessive preconditioning and wasted energy.

Referring again to FIG. 2, the method 12 may also include monitoring 48 a driving behavior of the vehicle 10 along the route of travel. For example, monitoring 48 may include evaluating whether the vehicle 10 is on the route of travel, evaluating whether the vehicle 10 is traveling at slower- or faster-than-anticipated speeds, and evaluating whether the vehicle 10 is aggressively changing lanes, turning, braking, and the like.

In addition, the method 12 may also include assigning 50 a confidence factor to the target preconditioning temperature based on the driving behavior. That is, if the driving conditions or behavior deviate from the initial inputs 24, 38, 44 (FIGS. 4 and 5), the confidence factor may alert the vehicle 10 and user that the target preconditioning temperature may require adjustment. For example, assigning 50 may include setting a 90% confidence factor to indicate that the method 12, 112 is 90% certain that the vehicle 10 will remain on the route of travel, will travel at posted speeds, and will decelerate at estimated opportunities. As such, assigning 50 the confidence factor may enable the method 12, 112 to gauge an effectiveness of the target preconditioning temperature for the energy storage device 14.

If the confidence factor falls below a designated threshold, e.g., below 50%, due to vehicle driving behavior or a change in route of travel conditions, the vehicle 10 may switch to vehicle thermal controls to warm or cool the energy storage device 14. For example, if the method 12, 112 detects a higher than expected output wattage of the energy storage device 14 due to a quick acceleration of the vehicle 10, higher vehicle speed, auxiliary loads, and/or a substantial rerouting of the route of travel, the confidence factor may decrease and the vehicle 10 may heat or condition the energy storage device 14 for a remainder of the route of travel to minimize stress on the energy storage device 14.

After heating 30 to the target preconditioning temperature, the vehicle 10 may alert the user that the energy storage device 14 is ready for travel, i.e., is optimized for the given route of travel, and that additional heat from electrical energy may be used to condition a passenger cabin of the vehicle 10 to provide for user comfort. That is, since energy capacity that is available for preconditioning the vehicle 10 may be shared between warming the energy storage device 14 and the passenger cabin, the method 12, 112 may allow for faster conditioning of the passenger cabin since the target preconditioning temperature is less than the full preconditioning temperature. Therefore, since the method 12, 112 may not over-precondition and may thereby conserve energy, the method 12, 112 may also reduce strain on components of the energy storage device 14 and vehicle 10 caused by temperature cycling.

As an additional advantage, since heating 30 a cold energy storage device 14 may cause noise and vibration in the passenger cabin from, for example, circulating pumps and spinning compressors, the tailored target preconditioning temperature provided by the method 12, 112 may also mitigate such occurrences.

Referring again to FIG. 2, the method 12 may further include, after heating 30, converting 52 kinetic energy of the vehicle 10 to electrical energy during at least one of deceleration of the vehicle 10 and frictional braking of the vehicle 10 while the vehicle is traveling along the route of travel, and transmitting 54 the electrical energy to the energy storage device 14 to thereby charge the energy storage device 14. That is, the method 12 may include employing regenerative braking and recharging the energy storage device 14 along the route of travel.

Referring now to FIG. 3, in another embodiment, the method 112 includes evaluating 126 the duration of travel along the route of travel and comparing 56 the duration of travel to a threshold duration of travel. In one example, the threshold duration of travel might be a delineator between a comparatively short trip and a comparatively long trip, such as 15 minutes or 30 minutes. For comparatively long trips, the energy storage device 14 may warm up to the full preconditioning temperature or operating temperature on its own as the energy storage device 14 transfers electrical energy to the vehicle 10. However, for comparatively short trips, evaluating 126 assists in selecting 28 the target preconditioning temperature that enables capturing the most energy possible from regenerative braking along the route of travel.

If the duration of travel is less than or equal to the threshold duration of travel, the method 112 includes estimating 26 the maximum energy available from regenerative braking along the route of travel; selecting 28 the target preconditioning temperature for the energy storage device 14 based on the route of travel, the duration of travel, and the maximum energy available for regenerative braking; and heating 30 the energy storage device 14 to the target preconditioning temperature. That is, the method 112 may be performed or continued for comparatively short trips that include at least some opportunity for regenerative braking.

As described with continued reference to FIG. 3, in one aspect, the method 112 may also include predicting 58 the destination input 24 (FIGS. 4 and 5), the soak time input 44 (FIGS. 4 and 5), and the destination departure time input 46 (FIGS. 4 and 5) based on a time of day. That is, the method 112 may include learning a driving habit of the user and predicting 58 when the method 12, 112 of preconditioning should begin or continue. For example, over time, the method 12, 112 may include learning user habits, driving style, destinations, duration and distance of travel, routes of travel, desired temperatures of the passenger cabin, and the like.

Additionally or alternatively, the method 112 may also include scheduling 60 the heating 30 according to the destination input 24 and a starting departure time. For example, the user may schedule the method 12, 112, e.g., via the toggle switch 42 (FIGS. 4 and 5), so that preconditioning is complete before the vehicle 10 departs from the starting location. That is, if the user knows that the vehicle 10 will be used at a certain time of day or on certain days of the week to travel to a repeat destination, the user may schedule 60 the heating 30 so that preconditioning is complete before departure.

Therefore, in summary, estimating 26, selecting 28, and heating 30 may include evaluating a plurality of variables.

For example, a temperature of the energy storage device 14 may be a function of an average temperature of the energy storage device 14, an ambient air temperature, a power required for an electric heater configured to heat coolant for the energy storage device 14, time, an electric load, and an initial temperature of the energy storage device 14.

As another example, the maximum energy available from regenerative braking or total recoverable energy for the route of travel may be a function of route inclinations and declinations, vehicle speed, a state of charge of the energy storage device 14, and traffic conditions.

Similarly, a filtered maximum energy available from regenerative braking or filtered total recoverable energy for the route of travel may be a function of route inclinations and declinations, an instantaneous power from regenerative braking, vehicle speed, time, and the total recoverable energy for the route of travel.

In another non-limiting example, an expected energy gain from regenerative braking for the route of travel may be a function of driving behavior or pattern of usage, a distance between the starting location of the vehicle 10 and the destination, the soak time after the vehicle 10 reaches the destination, and a probabilistic behavior of the user of the vehicle 10.

As a further example, a power derived from expected energy gains and duration of use of the vehicle 10 may be a function of the expected energy gain from regenerative braking for the route of travel and a total expected driving time.

By way of other non-limiting examples of functions and variables for the method 12, 112, the target preconditioning temperature may be based on a charge power limit of the energy storage device 14, the temperature of the energy storage device 14, and the expected energy available from regenerative braking for an upcoming route of travel; and may be a function of the power derived from expected energy gains and duration of use of the vehicle 10, a power limit of the energy storage device 14 based on a temperature of the energy storage device 14, a departure time, a current time, and a time remaining for preconditioning.

Likewise, the confidence factor may be a function of the driving behavior of pattern of usage, the distance between the starting location of the vehicle 10 and the destination, and the probabilistic behavior of the user of the vehicle 10.

The method 12, 112 as described herein may accept hardware inputs, software system inputs, and energy system inputs, and may produce energy management outputs.

Exemplary hardware inputs for the method 12, 112 may include, but are not limited to, wireless communications, a status of a charger plug for the energy storage device 14, high voltage thermal components of the vehicle 10, the temperature of the energy storage device 14, and the ambient temperature.

Exemplary software system inputs for the method 12, 112 may include, but are not limited to, vehicle speed, live traffic data, grade information for the route of travel, user-defined preconditioning constraints, navigation data, and thermal and regenerative braking limits of the energy storage device 14 and vehicle 10.

Exemplary energy system inputs for the method 12, 112, may include, but are not limited to, thermal power management of the energy storage device 14, such as heating and cooling requests and power limits; thermal power management of the passenger cabin, such as heating and cooling requests; and load and expected energy consumption associated with the route of travel.

Exemplary energy management outputs of the method 12, 112 may include, but are not limited to, reduced preconditioning power requirements for the energy storage device 14, optimized or maximized capture of regenerative braking energy based on live conditions along the route of travel, and high voltage thermal conditioning.

Therefore, in summary, the method 12, 112 may advantageously and precisely warm the energy storage device 14 so that the energy storage device 14 may capture an optimal amount of energy available from regenerative braking of the vehicle 10 during the short or limited travel while avoiding wasted energy associated with unnecessary or excessive preconditioning of the energy storage device 14. That is, the method 12, 112 precisely preconditions and warms the energy storage device 14 in preparation for a comparatively short duration trip so that the energy storage device 14 can capture as much energy from regenerative braking as possible without wasting the energy required for preconditioning. The method 12, 112 tailors the target preconditioning temperature to the specific route of travel so that energy is not wasted in heating 30 the energy storage device 14 to merely capture energy from a spike in regenerative braking. As such, the method 12, 112 does not over-precondition and thereby conserves energy, and reduces strains on components of the energy storage device 14 and vehicle 10 caused by temperature cycling.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may merely distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method of preconditioning an energy storage device for a vehicle, the method including:
determining a route of travel of the vehicle based on a destination input;
estimating a maximum energy available from regenerative braking of the vehicle along the route of travel;
selecting a target preconditioning temperature for the energy storage device based on the route of travel and the maximum energy available from regenerative braking; and
heating the energy storage device to the target preconditioning temperature to thereby precondition the energy storage device.

2. The method of claim 1, wherein the energy storage device further has a full preconditioning temperature, and heating includes warming the energy storage device to less than the full preconditioning temperature.

3. The method of claim 1, wherein selecting includes balancing the maximum energy available from regenerative braking with an energy required for heating the energy storage device to thereby avoid unnecessary preconditioning of the energy storage device.

4. The method of claim 1, wherein estimating includes assessing each opportunity for regenerative braking along the route of travel and rejecting outliers.

5. The method of claim 4, wherein estimating includes measuring a distance of the route of travel.

6. The method of claim 4, wherein estimating includes evaluating a duration of travel.

7. The method of claim 6, wherein estimating includes evaluating traffic volumes and traffic speeds along the route of travel.

8. The method of claim 4, wherein estimating includes analyzing weather conditions along the route of travel.

9. The method of claim 4, wherein estimating includes evaluating a grade of the route of travel.

10. The method of claim 1, wherein the route of travel connects a starting location of the vehicle and a destination of the vehicle, and further wherein selecting the target preconditioning temperature includes evaluating a soak time of the energy storage device at the destination based on a soak time input and a destination departure time input.

11. The method of claim 1, further including monitoring a driving behavior of the vehicle along the route of travel.

12. The method of claim 1, further including assigning a confidence factor to the target preconditioning temperature.

13. The method of claim 1, wherein the target preconditioning temperature is a minimum temperature that the energy storage device requires to capture the maximum energy available from regenerative braking for the route of travel; and
further including,
after heating, converting kinetic energy of the vehicle to electrical energy during at least one of deceleration of the vehicle and frictional braking of the vehicle while the vehicle is traveling along the route of travel; and
transmitting the electrical energy to the energy storage device to thereby charge the energy storage device.

14. A method of preconditioning an energy storage device for a vehicle, the method comprising:
determining a route of travel of the vehicle based on a destination input, wherein the route of travel connects a starting location of the vehicle and a destination of the vehicle;
evaluating a duration of travel along the route of travel;
comparing the duration of travel to a threshold duration of travel; and
if the duration of travel is less than or equal to the threshold duration of travel,
estimating a maximum energy available from regenerative braking of the vehicle along the route of travel;
selecting a target preconditioning temperature for the energy storage device based on the route of travel, the duration of travel, and the maximum energy available from regenerative braking; and
heating the energy storage device to the target preconditioning temperature to thereby precondition the energy storage device.

15. The method of claim 14, further including monitoring a driving behavior of the vehicle and assigning a confidence factor to the target preconditioning temperature based on the driving behavior.

16. The method of claim 14, further wherein selecting the target preconditioning temperature includes evaluating a soak time of the energy storage device at the destination based on a soak time input and a destination departure time input.

17. The method of claim 14, further including predicting the destination input, a soak time input, and a destination departure time input based on a time of day.

18. The method of claim 14, further including scheduling the heating according to the destination input and a starting departure time.

19. A vehicle comprising:
an energy storage device configured to store and discharge electrical energy;
a controller in communication with the energy storage device and including an instruction set that is executable to:
determine a route of travel of the vehicle based on a destination input;
estimate a maximum energy available from regenerative braking of the vehicle along the route of travel;
select a target preconditioning temperature of the energy storage device based on the route of travel and the maximum energy available from regenerative braking; and
heat the energy storage device to the target preconditioning temperature to thereby precondition the energy storage device.

20. The vehicle of claim 19, further including a plurality of wheels configured to translate along the route of travel; and
wherein the energy storage device is configured to provide motive power to at least one of the plurality of wheels.
